(19) United States
(12) Patent Application Publication
(10) Pub. No.: US 2017/0183787 A1
(43) Pub. Date: Jun. 29, 2017

(54) PHOTOCATALYST ELECTRODE FOR WATER DECOMPOSITION

(71) Applicants: FUJIFILM Corporation, Tokyo (JP); Japan Technological Research Association of Artificial Photosynthetic Chemical Process, Tokyo (JP); THE UNIVERSITY OF TOKYO, Tokyo (JP); TOKYO UNIVERSITY OF SCIENCE FOUNDATION, Tokyo (JP)

(72) Inventors: Chisato KATAYAMA, Tokyo (JP); Kazunari DOMEN, Tokyo (JP); Akihiko KUDO, Tokyo (JP); Ryo NIISHIRO, Kashiwa-shi (JP); Yongbo KUANG, Tokyo (JP); Masaharu YAMAGUCHI, Tokyo (JP); Koichiro UEDA, Tokyo (JP)

(73) Assignees: FUJIFILM Corporation, Tokyo (JP); Japan Technological Research Association of Artificial Photosynthetic Chemical Process, Tokyo (JP); THE UNIVERSITY OF TOKYO, Tokyo (JP); TOKYO UNIVERSITY OF SCIENCE FOUNDATION, Tokyo (JP)

(21) Appl. No.: 15/455,983

(22) Filed: Mar. 10, 2017

Related U.S. Application Data
(63) Continuation of application No. PCT/JP2015/074985, filed on Sep. 2, 2015.

(30) Foreign Application Priority Data
Sep. 12, 2014 (JP) 2014-186373

(51) Int. Cl. C25B 11/04; C25B 1/00; C25B 1/04; B01J 35/00

(52) U.S. Cl. CPC C25B 11/0405; B01J 35/004; C25B 1/003; C25B 1/04

(57) ABSTRACT

The present invention is to provide a photocatalyst electrode for water decomposition exhibiting a high photocurrent density and having reduced dark current. The photocatalyst electrode for water decomposition of the present invention has a photocatalyst layer and a current collector layer that is formed by a vapor deposition method and is disposed on the photocatalyst layer.

### CROSS-REFERENCE TO RELATED APPLICATIONS

This application is a Continuation of PCT International Application No. PCT/JP2015/074985 filed on Sep. 2, 2015, which claims priority under 35 U.S.C. §119(a) to Japanese Patent Application No. 2014-186373 filed on Sep. 12, 2014. The above application is hereby expressly incorporated by reference, in its entirety, into the present application.

### BACKGROUND OF THE INVENTION

1. Field of the Invention

The present invention relates to a photocatalyst electrode for water decomposition.

2. Description of the Related Art

From the viewpoint of reduction in carbon dioxide emission and use of clean energy, a technique of producing hydrogen or oxygen by decomposing water with a photocatalyst using solar energy is attracting attention.

A number of studies have been underway regarding a water decomposition reaction using a photocatalyst and, for example, a method of forming a photocatalyst electrode for water decomposition by a particle transfer method is disclosed in Chem. Sci., 2013, 4, 1120-1124. More specifically, in the particle transfer method, a photocatalyst electrode for water decomposition including a photocatalyst layer and a current collector layer is formed by, first, disposing a photocatalyst layer including photocatalyst particles on a substrate, further disposing a current collector layer on the photocatalyst layer, and then peeling off the current collector layer. In Chem. Sci., 2013, 4, 1120-1124, the formation of the current collector layer is performed by sputtering.

### SUMMARY OF THE INVENTION

On the other hand, in recent years, more efficient water decomposition has been required to proceed and a further improvement in the properties of a photocatalyst electrode has been required. In particular, it is required to realize a higher photocurrent density and to further reduce dark current.

The present inventors have found that when the above properties (photocurrent density and dark current) of the photocatalyst electrode for water decomposition obtained by forming a current collector layer by sputtering described in Chem. Sci., 2013, 4, 1120-1124 are evaluated, the levels recently required are not always satisfied and a further improvement is required.

The present invention has been made in consideration of the above circumstances and an object thereof is to provide a photocatalyst electrode for water decomposition exhibiting a high photocurrent density and having reduced dark current.

When the present inventors have conducted extensive studies on the problems of the related art, it has been found that the above problems can be solved by forming a current collector layer by a vapor deposition method.

That is, the present inventors have found that the above problems can be solved by adopting the following configurations.

(1) A photocatalyst electrode for water decomposition comprising: a photocatalyst layer; and a current collector layer that is formed by a vapor deposition method and is disposed on the photocatalyst layer.

(2) The photocatalyst electrode for water decomposition according to (1), further comprising: a contact layer including a semiconductor or a conductor between the photocatalyst layer and the current collector layer, in which the contact layer is formed by a vapor deposition method.

(3) The photocatalyst electrode for water decomposition according to (1) or (2), in which the vapor deposition method is a resistance heating vapor deposition method or an ion beam vapor deposition method.

(4) The photocatalyst electrode for water decomposition according to any one of (1) to (3), in which the current collector layer includes tin or gold.

(5) The photocatalyst electrode for water decomposition according to any one of (1) to (4), in which the resistance of the current collector layer is 4.0Ω/□ or less.

According to the present invention, it is possible to provide a photocatalyst electrode for water decomposition exhibiting a high photocurrent density and having reduced dark current.

### BRIEF DESCRIPTION OF THE DRAWINGS

FIG. 1 is a schematic cross-sectional view showing an embodiment of a photocatalyst electrode for water decomposition according to the present invention.

FIG. 2 is a schematic cross-sectional view showing another embodiment of the photocatalyst electrode for water decomposition according to the present invention.

FIGS. 3A to 3E are schematic cross-sectional views showing the order of steps of a method of producing a photocatalyst electrode for water decomposition according to an embodiment of the present invention.

### DESCRIPTION OF THE PREFERRED EMBODIMENTS

Hereinafter, the photocatalyst electrode for water decomposition according to the present invention will be described in detail.

First, one feature of the present invention as compared to those of the related art is forming a current collector layer by a vapor deposition method. Although the details for obtaining the effect of the present invention are not clear, it is presumed as follows. First, it is assumed that, a current collector layer is mainly formed on a photocatalyst layer by a sputtering method in the related art; however, in this method, the photocatalytic material in the photocatalyst layer during sputtering is damaged by plasma, and the current collector layer itself may be also damaged by plasma, thereby causing an increase in resistance. Thus, it is considered that various properties are deteriorated. When the present inventors choose a vapor deposition method as a method of forming a current collector layer, damage to the photocatalytic material and the current collector layer itself when the current collector layer formed is suppressed, and as a result, it is presumed that an increase in photocurrent density and a reduction in dark current are realized.

Furthermore, in the case of using tin as a material for the current collector layer, a surface oxide film is hardly formed compared to a case of using titanium, and thus a thin oxide film is formed between the photocatalyst layer and the current collector layer. As a result, it is presumed that an increase in photocurrent density and a reduction in dark current reduction are realized.

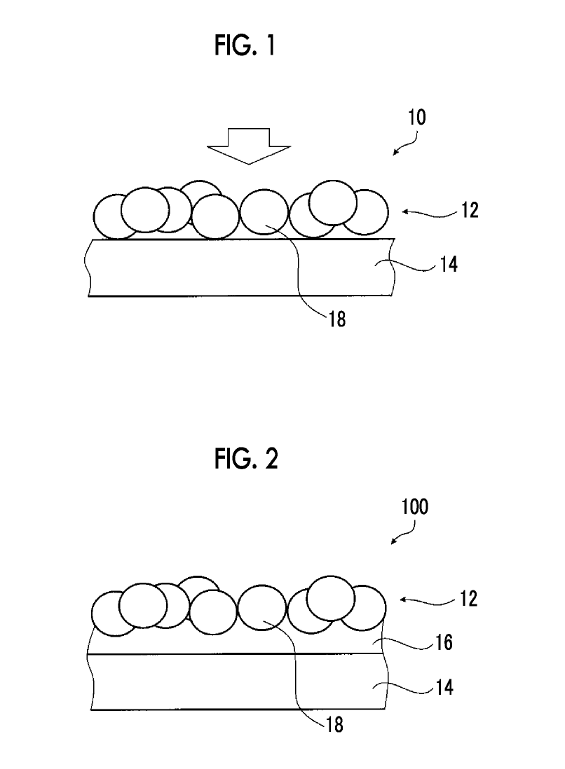

FIG. 1 is a cross-sectional view showing an embodiment of a photocatalyst electrode for water decomposition of the present invention. As shown in FIG. 1, a photocatalyst electrode for water decomposition (hereinafter, simply referred to as “electrode”) 10 includes a photocatalyst layer 12, and a current collector layer 14. In the electrode 10, electrons which are generated in the photocatalyst layer 12 by light irradiation flow into the current collector layer 14. Normally, the electrode 10 is often irradiated with light from the direction of the white arrow, and in this case, the surface of the photocatalyst layer 12 on the opposite side of the current collector layer 14 serves as a light receiving surface.

Incidentally, as another embodiment of the photocatalyst electrode for water decomposition, as shown in FIG. 2, an electrode 100 may further have a contact layer 16 between the photocatalyst layer 12 and the current collector layer 14.

Hereinafter, each member constituting the electrode will be described in detail.

<Photocatalyst Layer>

The photocatalyst layer is a layer including a photocatalyst (photocatalytic material), and in FIGS. 1 and 2, the photocatalyst layer 12 includes photocatalyst particles 18. The present invention is not limited to the embodiments shown in FIGS. 1 and 2, and the shape of the photocatalyst may be other than the granular shape.

Although the type of the photocatalyst is not particularly limited, specific examples of a photocatalyst at a hydrogen generation side for reducing hydrogen ions or water include oxides such as SrTiO₃, LaTi₂O₇, SnNb₂O₆, CuBi₂O₄, TiO₂ doped with Cr, Ni, Sb, Nb, Th, Rh, Sb and the like, SrTiO₃ doped with Cr, Sb, Ta, Rh, Na, Ga, K, La and the like, and LazTi₂O₇ or SnNb₂O₆ doped with Cr, Fe and the like;

oxynitride compounds such as LaTiO₂N, BaNbO₂N, CaTaO₂N, SrTaO₂N, BaTaO₂N, LaTaO₂N, Y₂Ta₂O₅N₂, Zr₁₊ₓGeN₂Oₓ, and Ga₁₋ₓZnₓN₁₋ₓOₓ (x represents a numerical value of 0 to 1; the same will be applied below);

nitride compounds such as Ta₃N₅, GaN, GaN doped with Mg, and Ge₃N₄;

sulfide compounds such as ZnS, ZnS doped with Cu, Ni, or Pb, CdS doped with Ag, CdₓZn₁₋ₓS, CuInS₂, CuIn₅S₈, CuGaS₂, CuGa₃S₅, CuGa₅S₈, AgGaS₂, AgGa₃S₅, AgGa₅S₈, AgGa_{0.9}In_{0.1}S₂, AgIn₅S₈, NaInS₂, AgInZn₇S₉, CuInGaS₂, Cu_{0.09}In_{0.09}Zn_{1.82}S₂, Cu_{0.25}Ag_{0.25}In_{0.5}ZnS₂, and Cu₂ZnSnS₄;

oxysulfide compounds such as Sm₂Ti₂O₅S₂, La₅Ti₂CuS₅O₇, La₅Ti₂AgS₅O₇, and La₅Ti₂AgO₅S₇;

oxysulfide compounds including La and In;

selenide compounds such as CuGaSe₂, CuGa₃Se₅, CuGa₅Se₈, AgₓCu₁₋ₓGaSe₂, AgₓCu₁₋ₓGa₃Se₅, AgₓCu₁₋ₓGa₅Se₈, AgGaSe₂, AgGa₃Se₅AgGa₅Se₈, and CuInGaSe₂;

oxyselenide compounds such as La₅Ti₂CuSe₅O₇, and La₅Ti₂AgSe₅O₇; and

chalcogenide compounds in which S and Se are partially mixed at an arbitrary ratio, such as La₅Ti₂Cu(Sₓ,Se₁₋ₓ)₅O₇, and La₅Ti₂Ag(Sₓ, Se₁₋ₓ)₅O₇.

In addition, as another embodiments of the photocatalyst, specific examples of a photocatalyst at a oxygen generation side for oxidizing water molecules or hydroxide ions to oxygen molecules include oxides such as TiO₂ doped with Cr, Ni, Sb, Nb, Th, Rh, Sb and the like, WO₃, BiWO₆, Bi₂MoO₆, In₂O₃(ZnO)₃, PbBi₂Nb₂O₉, BiVO₄, Ag₃VO₄, AgLi_{1/3}Ti_{2/3}O₂, and AgLi_{1/3}Sn_{2/3}O₂;

oxynitride compounds such as LaTiO₂N, CaNbO₂N, BaNbO₂N, SrNbO₂N, LaNbO₂N, TaON, CaTaO₂N, SrTaO₂N, BaTaO₂N, LaTaO₂N, Y₂Ta₂O₅N₂, Zr₁₊ₓGeN₂Oₓ, and Ga₁₋ₓZnₓN₁₋ₓOₓ;

nitride compounds such as Ta₃N₅, GaN, Ge₃N₄, Ta₃N₅ doped with Mg and Zr, and GaN doped with Mg;

oxysulfide compounds such as Sm₂Ti₂O₅S₂, and La₅Ti₂AgS₅O₇;

oxyselenide compounds such as La₅Ti₂AgSe₅O₇; and

chalcogenide compounds in which S and Se are partially mixed at an arbitrary ratio, such as La₅Ti₂Cu(Sₓ,Se₁₋ₓ)₅O₇, and La₅Ti₂Ag(Sₓ,Se₁₋ₓ)₅O₇.

The photocatalyst is preferably an oxynitride compound, a nitride compound, an oxysulfide compound, a sulfide compound, an oxyselenide compound, or a selenide compound, and more preferably an oxynitride compound, a nitride compound, an oxysulfide compound, or a selenide compound. Among these, a visible light responsive type photocatalyst is even more preferable.

The photocatalyst can be synthesized by known methods in the related art.

The average particle diameter of primary particles of the photocatalyst particles included in the photocatalyst layer is not particularly limited. From the viewpoint of achieving a high photoelectric conversion efficiency, the lower limit is preferably 1 nm or more, more preferably 10 nm or more, and even more preferably 50 nm or more. The upper limit is preferably 500 μm or less, more preferably 300 μm or less, even more preferably 200 μm or less, and particularly preferably 100 μm or less.

Here, the term “primary particles” refer to particles of minimum unit constituting a powder and the term “average particle diameter” refers to an arithmetical average value obtained by measuring the particle diameters (diameters) of 100 arbitrary particles of the photocatalyst observed by transmission electron microscopy (TEM) or scanning electron microscope (SEM) and averaging these diameters. In the case in which the particle shape is not a perfect round shape, the major axis is measured.

On the photocatalyst particles, as required, co-catalysts may be supported. It is preferable for the co-catalysts to use any of metals of Groups 2 to 14, intermetallic compounds and alloys of these metals, or oxides, composite oxides, nitrides, oxynitrides, sulfides, and oxysulfides thereof, or mixtures thereof. Here, the term “intermetallic compound” refers to a compound formed from two or more metal elements and a ratio between component atoms constituting the intermetallic compound does not necessarily refer to a stoichiometric ratio and includes a wide range of compositions. The term “oxides, composite oxides, nitrides, oxynitrides, sulfides, and oxysulfides thereof” refers to oxides, composite oxides, nitrides, oxynitrides, sulfides, and oxysulfides of metals of Groups 2 to 14, intermetallic compounds or alloys of these metals. The term “mixtures thereof” refers to mixtures of any two or more compounds of the above-exemplified compounds.

As the co-catalysts of the photocatalyst at an oxygen generation side, metals such as Ti, Mn, Fe, Co, Ni, Cu, Ru, Rh, Pd, Ag, In, Ta, W, Ir, Pt and Pb, and oxides and composite oxides thereof are preferable, metals such as Mn, Co, Ni, Ru, Rh, and Ir, and oxides or composite oxides thereof are more preferable, and Ir, MnO, MnO₂, Mn₂O₃, Mn₃O₄, CoO, CO₃O₄, NiCo₂O₄, RuO₂, Rh₂O₃, and IrO₂ are even more preferable.

As the photocatalyst at a hydrogen generation side, metals such as Pt, Pd, Rh, Ru, Ni, Au, Fe, Cr and Mo, and oxides, sulfides, or composite oxides thereof are preferable, Pt, Rh, Ru, and Rh—Cr oxide having a core-shell structure covered with Pt, Pd, Rh, Ru, Ni, Au, Fe, NiO, RuO₂, Cr—Rh oxide, MoS₂, Mo₃S₄, and Cr₂O₃, and the like are more preferable, and Pt, Rh, Ru, and Rh—Cr oxide having a core-shell structure covered with Pt, Pd, Rh, Ru, Ni, NiO, RuO₂, MoS₂, Mo₃S₄, and Cr₂O₃ are even more preferable.

Although the amount of the co-catalysts supported is not particularly limited, the amount of the co-catalysts supported is preferably 0.01% to 10% by mass, more preferably 0.01% to 5% by mass, and even more preferably 0.05% to 3% by mass with respect to (100% by mass of) the photocatalyst particles.

Although the thickness of the photocatalyst layer is not particularly limited, from the viewpoint of achieving a higher water decomposition efficiency, the thickness of the photocatalyst layer is preferably 0.01 to 3.0 μm and more preferably 0.5 to 2.0 μm.

<Current Collector Layer>

The current collector layer has a function of allowing electrons generated in the photocatalyst layer to flow.

The current collector layer is a layer that is formed on the photocatalyst layer by a vapor deposition method. That is, the current collector layer is a layer that is formed on the photocatalyst layer formed in advance in a vapor deposition method.

The vapor deposition method is a method (vacuum deposition method) including vaporizing or subliming a material to be laminated (formed into a film) by heating in vacuum, and attaching the material to the surface of a substrate (a member to be deposited) disposed at a remote position to form a thin film. The vapor deposition method is suitable from the viewpoint of forming a layer such that the layer forming in advance as described above (the photocatalyst layer) is not damaged.

As the vapor deposition method, know types of vapor deposition methods (for example, a resistance heating vapor deposition method, and an ion beam vapor deposition method) are known and the type thereof varies according to a heating method (heat source). Examples thereof include a resistance heating vapor deposition method, a high frequency heating vapor deposition method, an electron beam vapor deposition method, and an ion beam vapor deposition method (ion beam assist vapor deposition method).

The film formation rate during the vapor deposition method is not particularly limited and various film formation rates are set according to the material to be used. From the viewpoint of the properties and productivity of the current collector layer to be formed, the film formation rate is preferably 0.5 to 500 nm/s and more preferably 1 to 50 nm/s.

The material for constituting the current collector layer is not particularly limited and a material that can be formed by the vapor deposition method and exhibits conductive properties may be used. Examples thereof include elemental metals or alloys thereof. Specific examples of the material for constituting the current collector layer include Au, Al, Cu, Cd, Co, Cr, Fe, Ga, Ge, Hg, Ir, In, Mn, Mo, Nb, Ni, Pb, Pd, Pt, Ru, Re, Rh, Sb, Sn, Ta, Ti, V, W, Zn, TiN, TiO₂, Ta₃N₅, TaON, ZnO, SnO₂, indium tin oxide (ITO), SnO, TiO₂ (:Nb), SrTiO₃ (:Nb), fluorine-doped tin oxide (FTO), CuAlO₂, CuGaO₂, CuInO₂, ZnO(:Al), ZnO(:Ga), ZnO(:In), GaN, GaN(:C), GaN(:Si), GaN(:Sn), C, and alloys and mixture thereof.

In the present specification, the description of α(:β) means that a is doped with β. For example, TiO₂(:Nb) means that TiO₂ is doped with Nb.

Among these, from the viewpoint that the material in the current collector layer is hardly oxidized and conductive properties are further maintained, it is preferable that the current collector layer include tin (Sn) or gold (Au) and tin is more preferable.

Although the resistance value of the current collector layer is not particularly limited, from the viewpoint of obtaining further excellent properties (photocurrent density and dark current) of the photocatalyst electrode for water decomposition, the resistance value is preferably 4.0Ω/□ or less and more preferably 3.0Ω/□ or less. Although the lower limit is not particularly limited, the lower limit is 0.01Ω/□ or more in many cases.

The resistance value of the current collector layer is measured in such a manner that the resistance value of the current collector layer formed on the glass substrate is measured by a four-terminal four-probe method (model: LORESTA GP MCP-T610, probe PSP, manufactured by Mitsubishi Chemical Analytech Co., Ltd.).

Although the thickness of the current collector layer is not particularly limited, from the viewpoint of balance between conductive properties and costs, the thickness is preferably 0.1 μm to 10 mm and more preferably 1 μm to 2 mm.

The shape of the current collector layer is not particularly limited and any shape that can be produced by the above-described vapor deposition method may be adopted. For example, a porous material having a punching metal shape, a mesh shape, a lattice shape, or a penetrated pore may be adopted.

<Contact Layer>

The contact layer is an optional layer which may be disposed between the photocatalyst layer and the current collector layer. By disposing the contact layer, conductive paths between the photocatalyst layer and the current collector layer can be increased and thus photoelectric conversion efficiency can be improved. In addition, the photocatalyst layer and the contact layer can be firmly bonded and the photocatalyst layer can be prevented from being easily detached from the contact layer. In addition to the above-described properties, the contact layer sometimes functions as a strength reinforcing layer for the current collector layer, and for example, in the case of using tin for a current collector layer, the effect is significant.

In the case in which sufficient conduction paths are provided between the photocatalyst layer and the current collector layer and adhesiveness is excellent, the contact layer may not be provided.

The contact layer is a layer that is formed by a vapor deposition method similar to the current collector layer. The description of the vapor deposition method is the same as the description of the vapor deposition method of the current collector layer.

The contact layer is a layer including a semiconductor or a conductor. As the semiconductor or the conductor, materials exhibiting good electrical conductivity and not catalyzing a reverse reaction of water decomposition reaction and a reaction pairing the water decomposition reaction of the photocatalyst are preferably used.

Examples of the materials for constituting the contact layer include Au, Al, Cu, Cd, Co, Cr, Fe, Ga, Ge, Hg, Ir, In, Mn, Mo, Nb, Ni, Pb, Pd, Pt, Ru, Re, Rh, Sb, Sn, Ta, Ti, V, W, Zn, TiN, TiO₂, Ta₃N₅, TaON, ZnO, SnO₂, indium tin oxide (ITO), SnO, TiO₂(:Nb), SrTiO₃(:Nb), fluorine-doped tin oxide (FTO), CuAlO₂, CuGaO₂, CuInO₂, ZnO(:Al), ZnO(:Ga), ZnO(:In), GaN, GaN(:C), GaN(:Si), GaN(:Sn), C, and alloys and mixtures thereof.

Although the thickness of the contact layer is not particularly limited, the thickness may be the degree of capable of covering the side opposite of the light receiving surface of the photocatalyst layer. For example, the thickness is preferably 0.3 nm or more, more preferably 1 nm or more, and even more preferably 10 nm or more, and the thickness is 1 mm or less in most cases.

<Photocatalyst Electrode for Water Decomposition>

The photocatalyst electrode for water decomposition has at least the above-described photocatalyst layer and current collector layer. In addition, the photocatalyst electrode for water decomposition may have a contact layer between the photocatalyst layer and current collector layer.

The photocatalyst electrode for water decomposition may have layers other than the above-described layers. For example, in the case in which the photocatalyst electrode for water decomposition is prepared by a particle transfer method which will be descried later, a substrate for reinforcing, the mechanical strength of the electrode (corresponding to a second substrate which will be descried later) may be provided on the surface of the current collector layer on the opposite side of the photocatalyst layer side. In addition, an adhesive layer may be provided between the current collector layer and the substrate.

<Method of Producing Photocatalyst Electrode for Water Decomposition>

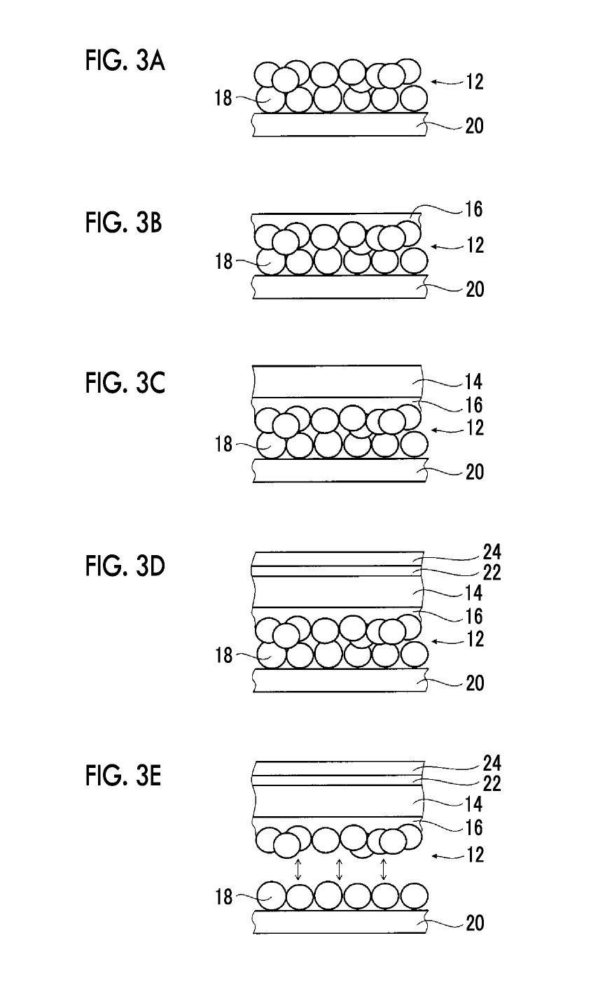

The method of producing a photocatalyst electrode for water decomposition is not particularly limited and the method by which the photocatalyst electrode for water decomposition of the above-described embodiment can be produced may be used. From the viewpoint of achieving further excellent properties (photocurrent density and dark current) of the photocatalyst electrode for water decomposition to be formed, the production method described using the following FIGS. 3A to 3E is preferable. In FIGS. 3A to 3E, a method of producing a photocatalyst electrode for water decomposition 100 including a photocatalyst layer 12, a contact layer 16, and a current collector layer 14 is shown. However, in the case of not providing the contact layer 16, Step S2 (contact layer forming step) which will be described later may not be performed.

FIGS. 3A to 3E are schematic views for illustrating the production step of the photocatalyst electrode for water decomposition according to the present invention.

The production method shown in FIGS. 3A to 3E includes at least Step S1 of forming a photocatalyst layer, Step S2 of forming a contact layer including a semiconductor or a conductor on one surface of the photocatalyst layer, and Step S3 of forming a current collector layer on the surface of the contact layer on the opposite side of the photocatalyst layer side. After Step S3 above, Step S4 of removing a non-contact photocatalyst may be carried out. Regarding Step S4, it is preferable to provide a reinforcing substrate forming step S4a or a washing step S4c as described later.

(Step S1: Photocatalyst Layer Forming Step)

Step S1 is a step of forming a photocatalyst layer. The method of forming a photocatalyst layer is not particularly limited and for example, a method of mixing photocatalyst particles and a binder and forming a photocatalyst layer by pressure molding, and a method of laminating a photocatalyst layer on a first substrate may be used. Particularly, since a strong layer can be formed without using a binder and impurities hardly enter between a photocatalyst layer and a contact layer (or a current collector layer), a method of laminating a photocatalyst layer on a first substrate to form a photocatalyst layer is preferable.

In FIGS. 3A to 3E, an embodiment of using a first substrate is described in detail. More specifically, in this step, as shown in FIG. 3A, the photocatalyst layer 12 is formed on a first substrate 20. The photocatalyst layer 12 includes photocatalyst particles 18.

As the first substrate used in this step, a substrate made of a material that is inactive to the reaction with the photocatalyst and has excellent chemical stability and heat resistance is preferably selected and for example, a glass plate, a Ti plate, and a Cu plate are preferable.

The surface of the first substrate on which the photocatalyst layer is disposed may be subjected to a polishing treatment and/or a washing treatment.

The method of forming the photocatalyst layer is not particularly limited and for example, the photocatalyst layer may be formed by forming a suspension by dispersing photocatalyst particles in a solvent, applying the suspension to the first substrate, and drying the suspension as required.

Examples of the solvent in the suspension include water, alcohols such as methanol and ethanol; ketones such as acetone; and aromatic compounds such as benzene, toluene, and xylene. In the case in which photocatalyst particles are dispersed in a solvent, the photocatalyst particles may be uniformly dispersed in the solvent by carrying out an ultrasonic treatment.

The method of applying the suspension to the first substrate is not particularly limited and for example, known methods such as a spray method, a dipping method, a squeegee method, a doctor blade method, a spin coating method, a screening method, a roll coating method, and an ink jet method may be used. In addition, a method of disposing the first substrate on the bottom of the container containing the suspension to precipitate the photocatalyst particles on the first substrate and then removing water may be used.

Regarding the condition for drying after the application, the temperature may be maintained at a temperature equal to or higher than the melting point of the solvent (a temperature at which the solvent can be vaporized) or heating may be carried out to a temperature to a degree of volatilizing the solvent in a short period of time (for example, about 15° C. to 200° C.).

It is preferable that in the photocatalyst layer formed according to the above procedure, the photocatalyst particles and the photocatalyst particles and the first substrate adhere to each other by electrostatic force of the photocatalyst particles.

In addition, it is preferable that the photocatalyst layer does not include other components such as a binder so that the formation of the conductive paths between the photocatalyst layer, and the contact layer or the current collector layer is not disturbed. In particular, it is preferable that the photocatalyst layer does not include a colored or insulating, binder.

(Step S2: Contact Layer Forming Step)

Step S2 is a step of forming a contact layer including a semiconductor or a conductor on one surface of the photocatalyst layer formed in Step S1. More specifically, in this step, as shown in FIG. 3B, a contact layer 16 is formed on the photocatalyst layer 12.

As the method of forming the contact layer (semiconductor or conductor), a vapor deposition method is adopted as described above. The vapor deposition method is as described above.

(Step S3: Current Collector Layer Forming Step)

Step S3 is a step of forming a current collector layer on the surface of the contact layer on the opposite side of the photocatalyst layer side formed in Step S2. More specifically, in this step, as shown in FIG. 3C, the current collector layer 14 is formed on the contact layer 16.

As the method of forming the current collector layer, a vapor deposition method is adopted as described above. The vapor deposition method is as described above.

(Step S4: Non-Contact Photocatalyst Removing Step)

Step S4 is a step of removing photocatalyst particles that do not come into contact with the contact layer. The removal method is not particularly limited and for example, a washing step S4c of removing the photocatalyst particles using a washing liquid of an ultrasonic washing treatment or the like can be applied.

Examples of the washing liquid used include water; an electrolyte aqueous solution; alcohols such as methanol and ethanol; aliphatic hydrocarbons such as pentane and hexane; aromatic hydrocarbons such as toluene and xylene; ketones such as acetone and methyl ethyl ketone; esters such as ethyl acetate; halogenides such as fluorocarbon; ethers such as diethyl ether and tetrahydrofuran; sulfoxides such as dimethylsulfoxide; and nitrogen-containing compounds such as dimethyl formamide. Among these, water and water soluble compounds such as methanol, ethanol and tetrahydrofuran are preferably used.

In the case in which the mechanical strength of the current collector layer is low and there is a concern of breakage in the photocatalyst electrode for water decomposition in Step S4, it is preferable that the electrode is subjected to the washing step S4c through the reinforcing substrate forming step S4a of forming a second substrate on the surface of the current collector layer on the opposite side of the contact layer side.

The method of forming, the second substrate is not particularly limited and for example, a method of causing the current collector layer and second substrate to adhere to each other using an adhesive such as a carbon tape or the like may be used. That is, as shown in FIG. 3D, a second substrate 24 can be attached to the surface of the current collector layer 14 on the opposite side of the contact layer 16 side through an adhesive layer 22.

In addition, in the case in which the photocatalyst particles are laminated on the first substrate in Step S1 above, it is preferable that the photocatalyst particles that do not come in contact with the contact layer are removed by the washing step S4c after passing a substrate removing step S4b of removing the first substrate (preferably after the substrate removing step S4b subsequent to the reinforcing substrate forming step S4a as shown in FIG. 3E).

The removal method of the first substrate carried out in the substrate removing step S4b is not particularly limited. Examples of the removal method include a method of mechanically removing a first substrate, a method of removing the first substrate by dipping in water to wet a photocatalyst particle lamination portion, thereby weakening the bonding between the photocatalyst particles, a method of removing a substrate by dissolving the substrate in a chemical such as an acid or an alkali, and a method of removing a substrate by physically destroying the substrate. A method of peeling a substrate is preferable from the viewpoint that the possibility of damage of the photocatalyst layer is low. The contact layer and some of the non-contact photocatalyst particles can be physically removed together with the first substrate by the substrate removing step S4b (FIG. 3E).

On the other hand, the photocatalyst particles that come in contact with the contact layer are physically firmly bonded to the contact layer to a certain extent. Therefore, when the first substrate is removed, the photocatalyst particles remain at the contact layer side without dropping out. In this case, the non-contact photocatalyst particles that have not been removed in the substrate removing step S4b are preferably further subjected to a removal treatment by the washing step S4c.

The photocatalyst electrode for water decomposition including the above-described photocatalyst layer and current collector layer, and further including a contact layer, which is an optional constitutional component, exhibits the above-described excellent effect.

The photocatalyst electrode for water decomposition comes into contact with water and is irradiated with light so that water decomposition proceeds. Thus, oxygen or hydrogen is generated. In particular, the above-described photocatalyst electrode for water decomposition can be suitably used as a so-called anode electrode.

The light to be applied may be light capable of causing a photodecomposition reaction, and specifically, visible light such as sunlight, ultraviolet light, infrared light and the like can be used. Among these, sunlight whose amount is inexhaustible is preferable.

In addition, a water decomposition apparatus including the above-described photocatalyst electrode for water decomposition exhibits excellent properties, and as configurations other than the photocatalyst electrode for water decomposition (for example, a counter electrode or the like), known configurations may be used.

### EXAMPLES

The present invention is described more specifically below by reference to examples, but the invention is not limited by the following examples.

### Synthesis Example 1: SnNb₂O₆

1.35 g of stannous oxide: SnO (manufactured by Wako Pure Chemical Industries, Ltd.) and 2.66 g of niobium oxide: Nb₂O₅ (manufactured by Sigma-Aldrich Co. LLC.) were mixed in an agate mortar and then the mixture was put into an alumina boat. The mixture was subjected to an annealing treatment in an electric tube furnace under the condition of a nitrogen flow rate of 50 mL/min at 800° C. for 10 hours. The obtained powder was pulverized in an agate mortar. It was confirmed that the obtained powder was SnNb₂O₆ from the measurement with X-ray diffraction (XRD, powder X-ray diffraction apparatus, manufactured by Rigaku Corporation, fully-automated horizontal type multipurpose X-ray diffraction apparatus Smart Lab).

### Synthesis Example 2: Rh and Sb—Co-Doped TiO₂ Having Cobalt Oxide Supported Thereon (CoOₓ/TiO₂:Rh,Sb)

4.61 g of titanium oxide: TiO₂ (manufactured by Japan Pure Chemical Co., Ltd.), 0.099 g of rhodium oxide: Rh₂O₃ (manufactured by Wako Pure Chemical Industries, Ltd.), and 0.227 g of antimony oxide: Sb₂O₃ (manufactured by Nacalai Tesque, Inc.) were mixed in an agate mortar (atom ratio Ti/Rh/Sb=0.961/0.013/0.026). The obtained mixture was put into an alumina crucible, sintered in an electric furnace at 900° C. for 1 hour in the atmosphere and then pulverized, and put into an alumina crucible. The resultant was further sintered in an electric furnace at 1,150° C. for 10 hours in the atmosphere. The obtained photocatalyst powder was pulverized in an agate mortar. A single phase of titanium oxide (having a rutile structure) was confirmed by XRD measurement.

0.05 g of the obtained photocatalyst powder was put into a magnetic evaporating dish and 25 μL of a 0.344 mol/L (in terms of Co) aqueous solution in which 500 μL of water and cobalt nitrate: Co(NO₃)₂.6H₂O (manufactured by Wako Pure Chemical Industries, Ltd.) were dissolved was added thereto. The mixture was evaporated and dried on a hot plate at 120° C. and then sintered in an electric furnace at 300° C. for 2 hours in the atmosphere. It was confirmed from SEM observation that the co-catalyst (cobalt oxide) was supported on the photocatalyst powder.

### Synthesis Example 3: Rh and Sb—Co-Doped SrTiO₃ Having Cobalt Oxide Supported Thereon (CoOₓ/STO:Rh, Sb)

Into a 200 mL TEFLON (registered trademark) container containing 27.5 mL of water, 10.6 g of strontium hydroxide: Sr(OH)₂.8H₂O (manufactured by Japan Pure Chemical Co., Ltd.), 3.04 g of titanium oxide: TiO₂ (manufactured by Nippon Aerosil Co., Ltd.), and 0.194 g of antimony oxide: Sb₂O₅ (manufactured by Japan Pure Chemical Co., Ltd.) were put and stirred to obtain a suspension. To the obtained suspension, 22.5 mL of a 35.6 mmol/L (in terms of Rh) aqueous solution in which rhodium nitrite: Rh(NO₃)₃ (manufactured by Kanto Chemical Co., Inc.) was dissolved was added and the mixture was fully stirred (atom ratio Sr/Ti/Rh/Sb=1.00/0.95/0.02/0.03). Next, the TEFLON (registered trademark) container was put into a stainless steel reaction container and subjected to a hydrothermal treatment at 160° C. for 20 hours using a hydrothermal reaction apparatus. The obtained precipitate was washed with water of 80° C. three times and then separated and collected by centrifugal separation. The collected precipitate was dried at 60° C. over one night and pulverized. The obtained precipitate was put into an alumina crucible, sintered in an electric furnace at 1,150° C. for 10 hours in the atmosphere, and pulverized in an agate mortar. It was confirmed by XRD measurement that the obtained photocatalyst powder exhibited a single phase of strontium titanate.

0.05 g of the obtained photocatalyst powder was put into a magnetic evaporating dish and 25 μL of a 0.344 mol/L (in terms of Co) aqueous solution in which 500 μL of water and cobalt nitrate: Co(NO₃)₂.6H₂O (manufactured by Wako Pure Chemical Industries, Ltd.) were dissolved was added thereto. The mixture was evaporated and dried on a hot plate at 120° C. and then sintered in an electric furnace at 300° C. for 2 hours in the atmosphere. It was confirmed from SEM observation that the co-catalyst (cobalt oxide) was supported on the photocatalyst powder.

### Synthesis Example 4: BaNbO₂N Having Cobalt Oxide Supported Thereon

NbCl₅ (manufactured by Kojundo Chemical Lab. Co., Ltd., 3N, 2.93 g), BaCO₃ (manufactured by Kanto Chemical Co., Inc., 3N, 2.68 g), citric acid (manufactured by Wako Pure Chemical Industries, Ltd., 23.5 g), ethylene glycol (manufactured by Wako Pure Chemical Industries, Ltd., special grade reagent, 30.3 g), and methanol (manufactured by Wako Pure Chemical Industries, Ltd., 99.5%, 39.1 g) were mixed (Ba/Nb (molar ratio)=1.25), and the mixture was uniformly stirred on a hot stirrer to conduct complexing. Subsequently, the obtained mixture was heated at 350° C. with a mantle heater of 350° C. for 3 hours and carbonated. Next, the resultant was further heated on an alumina board at 500° C. for 5 hours to obtain a white solid. Furthermore, the obtained solid was sintered at 700° C. for 2 hours and then further sintered at 800° C. for 3 hours. The generation of the obtained Ba₅Nb₄O₁₅ was confirmed by XRD. The obtained Ba₅Nb₄O₁₅ was subjected to a nitrogen treatment in an electric tube furnace at 850° C. for 50 hours in a 100% ammonia gas flow (500 ml/min). Thereafter, the surface of a product was subjected to a washing treatment with 1 M nitric acid and thus barium niobium oxynitride (BaNbO₂N) was obtained. The generation of barium niobium oxynitride was confirmed by XRD. In addition, it was confirmed by diffuse reflection spectrum measurement that the absorption edge of barium niobium oxynitride was 740 nm. The Ba/Nb (molar ratio) refers to the ratio between the molar amount of a barium atom derived from BaCO₃ and the molar amount of a niobium atom derived from NbCl₅.

A suspension (solvent: H₂O) of barium niobium oxynitride obtained using a magnetic evaporating dish was prepared and an aqueous solution of cobalt nitrate was added to the suspension so that Co/BaNbO₂N was 2% by mass in terms of mass ratio. Then, the mixture was stirred using a glass rod while heating the magnetic evaporating dish with water vapor flying upwards from a beaker containing boiled water.

The obtained powder was heated in an ammonia gas flow (200 ml/min) at 500° C. for 1 hour and further heated in an oxygen atmosphere at 200° C. for 1 hour to produce a photocatalyst powder. The obtained photocatalyst powder was observed using a SEM-EDX (apparatus name: SU-8020, manufactured by Hitachi High-Technologies Corporation) and consequently, it was confirmed that the co-catalyst (cobalt oxide) was supported on barium niobium oxynitride.

### Synthesis Example 5: BiVO₄

An aqueous nitric acid solution (2.0 mol/1, 100 ml) of 6.0 mmol of NH₄VO₃ (Kanto Chemical Co., Inc., 99.0%) and an aqueous nitric acid solution (2.0 mol/1, 100 ml) including 6.0 mmol of Bi(NO₃)₃.5H₂O (Kanto Chemical Co., Inc., 99.9%) were respectively prepared. The respective solutions were stirred for 30 minutes and then two types of solutions were mixed at 1:1 (molar ratio). Next, 5 g of urea (Kanto Chemical Co., Inc., 99.0%) was added to the obtained solution. The obtained solution was sealed in a stainless steel autoclave of a 100 ml TEFLON (registered trademark) inner cylinder and a microwave hydrothermal reaction was conducted at 200° C. for 60 minutes to produce BiVO₄. It was confirmed by XRD measurement that the obtained photocatalyst powder exhibited a single phase of BiVO₄.

<Preparation of Photocatalyst Electrode for Water Decomposition>

Titanium oxide (product name: TIO14BP, manufactured by Kojundo Chemical Lab. Co., Ltd.) was suspended in a low boiling point organic solvent (solvent: isopropyl alcohol) to prepare a suspension. The concentration of the photocatalyst powder (titanium oxide) in the suspension was 1.66% by mass.

Next, the obtained suspension was applied to the substrate (float plate glass (FL glass)) and dried to prepare a substrate A with a photocatalyst layer on which a photocatalyst layer was disposed on the substrate.

Further, substrates B to F with a photocatalyst layer were respectively prepared in the same procedure as described above except that instead of using the titanium oxide, the photocatalyst powders (photocatalyst particles) produced in the above Synthesis Examples 1 to 5 were used respectively.

### Examples 1 to 6

A titanium layer (thickness: 600 nm), which becomes a contact layer, was laminated on the photocatalyst layer of the substrate A with a photocatalyst layer by a vapor deposition method. The apparatus used was VPC-260F manufactured by ULVAC KIKO, Inc. and the film formation rate was 5 nm/s.

Next, a tin layer (4.4 μm), which becomes a current collector layer, was laminated on the contact layer by a vapor deposition method. The apparatus used was VPC-260F manufactured by ULVAC KIKO, Inc. and the film formation rate was 5 nm/s.

Next, a glass substrate (soda lime glass) was attached onto the current collector layer using a carbon tape. Then, the substrate (FL glass) was peeled off from the obtained laminate (of the substrate (FL glass), photocatalyst layer, contact layer, current collector layer, carbon tape layer, and glass substrate (soda lime glass)) and the laminate was subjected to ultrasonic washing in pure water for 10 minutes to obtain a photocatalyst electrode for water decomposition.

Photocatalyst electrodes for water decomposition were respectively prepared in the same procedure as described above except that instead of using the substrate A with a photocatalyst layer, the substrates B to F with a photocatalyst layer were respectively used.

The thickness of the photocatalyst layer in the substrates A to F with a photocatalyst layer obtained above was about 0.5 to 2.0 μm.

When film formation was directly carried out on the glass substrate under the same conditions as the conditions for vapor deposition, the resistance values of the titanium layer and the tin layer were respectively 2.8Ω/□ and 0.4 Ω/□.

### Synthesis Example 6: BaTaO₂N

0.88 g of tantalum oxide (manufactured by Japan Pure Chemical Co., Ltd.) and 0.79 g of barium carbonate (Kanto Chemical Co., Inc.) were pulverized and mixed in an agate mortar, then put into an alumina board, and sintered in a box type electric furnace at 1,000° C. for 10 hours to obtain an oxide precursor. The precursor was subjected to a nitriding treatment in an electric tube furnace at 900° C. for 10 hours in a 100% ammonia gas flow (200 ml/min). The obtained powder was pulverized in an agate mortar. It was confirmed by XRD measurement that the obtained powder was barium tantalum oxynitride (BaTaO₂N).

### Example 7

The photocatalyst powder (photocatalyst particles) produced in the Synthesis Example 6 was suspended in a low boiling point organic solvent (solvent: methanol) to prepare a suspension. The concentration of the photocatalyst powder (BaTaO₂N) in the suspension was 6.3% by mass.

Next, the obtained suspension was applied to a substrate (float plate glass (FL glass)) and dried to prepare a substrate G with a photocatalyst layer on which a photocatalyst layer (thickness: 0.5 to 2.0 μm) was disposed on the substrate.

A titanium layer (thickness: 600 nm), which becomes a contact layer, was laminated on the photocatalyst layer of the substrate G with a photocatalyst layer by a vapor deposition method. The apparatus used was VPC-260F manufactured by ULVAC KIKO, Inc. and the film formation rate was 5 nm/s.

Next, a tin layer (4.4 μm), which becomes a current collector layer, was laminated on the contact layer by a vapor deposition method. The apparatus used was VPC-260F manufactured by ULVAC KIKO, Inc. and the film formation rate was 5 nm/s. The metal film (the laminate of the photocatalyst layer, the contact layer, and the current collector layer) was peeled off from the substrate (float plate glass (FL glass)) and subjected to ultrasonic washing in pure water for 10 minutes to obtain a photocatalyst electrode for water decomposition (BaTaO₂N electrode).

(Co-Catalyst Support)

10 mM of Co(NO₃)₃.6H₂O was dissolved in a solution of 0.1 M-K₂HPO₄ and 0.1 M-KH₂PO₄ of pH 7 and the BaTaO₂N electrode prepared was immersed in the solution. In electrochemical measurement method of a three-electrode system in which the BaTaO₂N electrode was used as an action electrode, an Ag/AgCl electrode was used as a reference electrode, and a Pt wire was used as a counter electrode, 1.1 V (vs Ag/AgCl) was applied for 100 seconds, and a co-catalyst was supported on the BaTaO₂N electrode. Thereafter, the electrode was washed with distilled water to obtain a photocatalyst electrode for water decomposition.

### Synthesis Example 8

BiVO₄ was synthesized in the same manner as in Synthesis Example 5. Next, a suspension of BiVO₄ (solvent: H₂O) was prepared in a magnetic crucible and an aqueous cobalt nitrate solution was added to the suspension so that a Co/BiVO₄ mass ratio of {(Co/BiVO₄)×100} was 0.5% by mass. Then, the mixture was stirred using a glass rod while heating the magnetic crucible with water vapor flying upwards from a beaker containing boiled water.

The obtained powder was heated at 400° C. for 2 hours in the atmosphere to produce BiVO₄ on which cobalt oxide was supported.

A substrate H with a photocatalyst layer (thickness: 0.5 to 2.0 μm) was prepared in the same procedure as in Example 1 except that the photocatalyst electrode for water decomposition was prepared using the photocatalyst powder (photocatalyst particles) prepared in the Synthesis Example 8 instead of using titanium oxide.

### Example 8

A titanium layer (thickness: 1 μm), which becomes a contact layer, was laminated on the photocatalyst layer of the substrate H with a photocatalyst layer by a vapor deposition method. The apparatus used was VPC-260F manufactured by ULVAC KIKO, Inc. and the film formation rate was 5 nm/s.

Next, a gold layer (2 μm), which becomes a current collector layer, was laminated on the contact layer by a vapor deposition method. The apparatus (VPC-260F) manufactured by ULVAC KIKO, Inc. was used and the film formation rate was 5 nm/s. The metal film (the laminate of the photocatalyst layer, the contact layer, and the current collector layer) was peeled off from a substrate (flow plate glass (FL glass)) and subjected to ultrasonic washing in pure water for 10 minutes to obtain a photocatalyst electrode for water decomposition.

### Comparative Examples 1 to 6

A titanium layer (thickness: 4 μm), which becomes a current collector layer, was laminated respectively on the photocatalyst layer of the substrate A with a photocatalyst layer by a sputtering method. The apparatus used was CS-S manufactured by ULVAC KIKO, Inc. and the temperature of the substrate was 300° C.

Photocatalyst electrodes for water decomposition were prepared using the obtained substrate with a current collector layer in the same procedure as in Examples 1 to 6.

Photocatalyst electrodes for water decomposition were prepared in the same procedure as described above except that instead of using the substrate A with a photocatalyst layer, the substrates B to F with a photocatalyst layer were used respectively.

When film formation was directly carried out on the glass substrate under the same conditions as the conditions for vapor deposition, the resistance values of the titanium layer was 6.8 Ω/□.

<Evaluation of Electrode>

(Photocurrent Density)

The evaluation of the photocurrent density of each of the prepared photocatalyst electrodes for water decomposition was carried by current-potential measurement in a three-electrode system out using a potentiostat. A separatable flask having a planar window was used as an electrochemical cell, an Ag/AgCl electrode was used as a reference electrode, and a Pt wire was used as a counter electrode. A 0.1M KBi buffer solution (pH=9.3) was used as an electrolyte solution. Oxygen and carbon dioxide dissolved were removed by filling the inside of the electrochemical cell with argon and sufficiently conducting bubbling before the measurement. In the electrochemical measurement, a solar simulator (AM 1.5G) was used as a light source.

The photocurrent density (mA/cm²) of the photocatalyst electrodes for water decomposition prepared in the above Examples 1 to 8 and Comparative Examples 1 to 6 at a measurement potential of 1.2 V (vs. RHE) was measured.

Regarding dark current, the current value in the case of no light irradiation at measurement potentials of 1.2 V (vs. RHE) and 1.4 V (vs. RHE) was evaluated.

The results are shown in Table 1 below. In Table 1, the term “Dark current density evaluation 1” represents the evaluation at the measurement potential of 1.2 V (vs. RHE) and the term “Dark current density evaluation 2” represents the evaluation at the measurement potential of 1.4 V (vs. RHE).

In addition, regarding Example 8, a 0.1 M KPi buffer solution (pH=7.0) was used an electrolyte solution.

TABLE 1

| | | | Evaluation | | |
|---|---|---|---|---|---|
| | | Type of | Evaluation of | Dark current | Dark current |
| | | substrate with | photocurrent | density | density |
| | Type of | photocatalyst | density | evaluation 1 | evaluation 2 |
| | photocatalyst layer | layer | (mA/cm²) | (mA/cm²) | (mA/cm²) |
| Example 1 | TiO₂ | A | 0.66 | 0.03 | 0.03 |
| Example 2 | SnNb₂O₆ | B | 0.06 | 0.02 | 0.03 |
| Example 3 | CoOₓ:TiO₂:Rh, Sb | C | 0.15 | 0.02 | 0.03 |
| Example 4 | CoOₓ:STO:Rh, Sb | D | 0.15 | 0.01 | 0.03 |
| Example 5 | CoOₓ:BaNbO₂N | E | 0.59 | 0.00 | 0.00 |
| Example 6 | BiVO₄ | F | 1.26 | 0.04 | 0.04 |
| Example 7 | CoOₓ:BaTaO₂N | G | 1.1 | 0.01 | 0.02 |
| Example 8 | BiVO₄ | H | 1.7 | 0.03 | 0.08 |
| Comparative | TiO₂ | A | 0.34 | 0.03 | 0.04 |
| Example 1 | | | | | |
| Comparative | SnNb₂O₆ | B | 0.03 | 0.03 | 0.06 |
| Example 2 | | | | | |
| Comparative | CoOₓ:TiO₂:Rh, Sb | C | 0.05 | 0.02 | 0.05 |
| Example 3 | | | | | |
| Comparative | CoOₓ:STO:Rh, Sb | D | 0.13 | 0.01 | 0.06 |
| Example 4 | | | | | |
| Comparative | CoOₓ:BaNbO₂N | E | 0.14 | 0.00 | 0.03 |
| Example 5 | | | | | |
| Comparative | BiVO₄ | F | 0.68 | 0.10 | 0.13 |
| Example 6 | | | | | |

As shown in the above Table, in Example 1 in which the current collector layer was prepared by a vapor deposition method, the photocurrent density was high and the generation of dark current was also suppressed compared to Comparative Example 1 in which the current collector layer was prepared by a sputtering method. The same results were continued from the respective comparisons of Examples 2 to 6 and Comparative Examples 2 to 6.

### EXPLANATION OF REFERENCES

10, 100: photocatalyst electrode for water decomposition
12: photocatalyst layer
14: current collector layer
16: contact layer
18: photocatalyst particles
20: first substrate
22: adhesive layer
24: second substrate

What is claimed is:

1. A photocatalyst electrode for water decomposition comprising:
a photocatalyst layer; and
a current collector layer that is formed by a vapor deposition method and is disposed on the photocatalyst layer.

2. The photocatalyst electrode for water decomposition according to claim 1, further comprising:
a contact layer including a semiconductor or a conductor between the photocatalyst layer and the current collector layer,
wherein the contact layer is formed by a vapor deposition method.

3. The photocatalyst electrode for water decomposition according to claim 1,
wherein the vapor deposition method is a resistance heating vapor deposition method or an ion beam vapor deposition method.

4. The photocatalyst electrode for water decomposition according to claim 2,
wherein the vapor deposition method is a resistance heating vapor deposition method or an ion beam vapor deposition method.

5. The photocatalyst electrode for water decomposition according to claim 1,
wherein the current collector layer includes tin or gold.

6. The photocatalyst electrode for water decomposition according to claim 2,
wherein the current collector layer includes tin or gold.

7. The photocatalyst electrode for water decomposition according to claim 3,
wherein the current collector layer includes tin or gold.

8. The photocatalyst electrode for water decomposition according to claim 4,
wherein the current collector layer includes tin or gold.

9. The photocatalyst electrode for water decomposition according to claim 1,
wherein the current collector layer includes tin.

10. The photocatalyst electrode for water decomposition according to claim 2,
wherein the current collector layer includes tin.

11. The photocatalyst electrode for water decomposition according to claim 3,
wherein the current collector layer includes tin.

12. The photocatalyst electrode for water decomposition according to claim 4,
wherein the current collector layer includes tin.

13. The photocatalyst electrode for water decomposition according to claim 5,
wherein the current collector layer includes tin.

14. The photocatalyst electrode for water decomposition according to claim 6,
wherein the current collector layer includes tin.

15. The photocatalyst electrode for water decomposition according to claim 7,
wherein the current collector layer includes tin.

16. The photocatalyst electrode for water decomposition according to claim 8,
wherein the current collector layer includes tin.

17. The photocatalyst electrode for water decomposition according to claim 1,
wherein the resistance of the current collector layer is 4.0Ω/□ or less.

18. The photocatalyst electrode for water decomposition according to claim 2,
wherein the resistance of the current collector layer is 4.0Ω/□ or less.

19. The photocatalyst electrode for water decomposition according to claim 3,
wherein the resistance of the current collector layer is 4.0Ω/□ or less.

20. The photocatalyst electrode for water decomposition according to claim 4,
wherein the resistance of the current collector layer is 4.0Ω/□ or less.
